(19) United States
(12) Patent Application Publication
(10) Pub. No.: US 2010/0121994 A1
(43) Pub. Date: May 13, 2010

(54) STACKED MEMORY ARRAY

(75) Inventors: Kyu-hyoun Kim, Mount Kisco, NY (US); Paul W. Coteus, Yorktown Heights, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/267,646

(22) Filed: Nov. 10, 2008

(51) Int. Cl. G06F 3/00; G06F 13/28

(52) U.S. Cl. 710/51; 710/308

(57) ABSTRACT

A memory subsystem, array controller, method, and design structure are provided for a stacked memory array. The memory subsystem includes an array controller and at least one memory array. The array controller includes a primary and secondary buffer interface to communicate with a memory controller via a cascade interconnected bus. The array controller also includes an array access controller to process memory access commands received via one of the primary and secondary buffer interfaces. The at least one memory array includes a memory cell array die separately packaged with respect to the array controller and coupled to the array controller in a stacked configuration via memory core data lines using through silicon vias (TSVs).

### BACKGROUND

This invention relates generally to computer memory systems, and more particularly to stacked memory arrays in a memory system.

Contemporary high performance computing main memory systems are generally composed of one or more dynamic random access memory (DRAM) devices, which are connected to one or more processors via one or more memory control elements. DRAM devices typically include memory cells arranged in horizontal grids with row and column decoding logic to access values stored at specific addresses. Overall computer system performance is affected by each of the key elements of the computer structure, including the performance/structure of the processor(s), any memory cache(s), the input/output (I/O) subsystem(s), the efficiency of the memory control function(s), the main memory device(s), and the type and structure of the memory interconnect interface(s).

Extensive research and development efforts are invested by the industry, on an ongoing basis, to create improved and/or innovative solutions to maximizing overall system performance and density by improving the memory system/subsystem design and/or structure. High-availability systems present further challenges as related to overall system reliability due to customer expectations that new computer systems will markedly surpass existing systems in regard to mean-time-between-failure (MTBF), in addition to offering additional functions, increased performance, reduced latency, increased storage, lower operating costs, etc. Other frequent customer requirements further exacerbate the memory system design challenges, and include such items as ease of upgrade and reduced system environmental impact (such as space, power and cooling).

### SUMMARY

An exemplary embodiment is a memory subsystem including an array controller and at least one memory array. The array controller includes a primary and secondary buffer interface to communicate with a memory controller via a cascade interconnected bus. The array controller also includes an array access controller to process memory access commands received via one of the primary and secondary buffer interfaces. The at least one memory array includes a memory cell array die separately packaged with respect to the array controller and coupled to the array controller in a stacked configuration via memory core data lines using through silicon vias (TSVs).

Another exemplary embodiment is an array controller that includes a primary and secondary buffer interface to communicate with a memory controller via a cascade interconnected bus. The array controller also includes an array access controller to process memory access commands received via one of the primary and secondary buffer interfaces. The array controller further includes a TSV interface to communicate via memory core data lines with at least one memory array comprising a memory cell array die separately packaged with respect to the array controller in a stacked configuration.

A further exemplary embodiment is a method for providing a stacked memory array. The method includes configuring an array controller to communicate with a memory controller via a cascade interconnected bus. The array controller is coupled to the cascade interconnected bus via one of: a primary and secondary buffer interface. The method further includes processing a memory access command received via one of the primary and secondary buffer interfaces. The method additionally includes performing a memory access on at least one memory array in response to processing the memory access command. The at least one memory array includes a memory cell array die separately packaged with respect to the array controller and coupled to the array controller in a stacked configuration via memory core data lines using TSVs. An additional exemplary embodiment is a design structure tangibly embodied in a machine-readable medium for designing, manufacturing, or testing an integrated circuit. The design structure includes a primary and secondary buffer interface to communicate with a memory controller via a cascade interconnected bus. The design structure further includes an array access controller to process memory access commands received via one of the primary and secondary buffer interfaces. The design structure also includes a TSV interface to communicate via memory core data lines with at least one memory array including a memory cell array die separately packaged with respect to the array controller in a stacked configuration.

Other systems, methods, apparatuses, and/or design structures according to embodiments will be or become apparent to one with skill in the art upon review of the following drawings and detailed description. It is intended that all such additional systems, methods, apparatuses, and/or design structures be included within this description, be within the scope of the present invention, and be protected by the accompanying claims.

### BRIEF DESCRIPTION OF THE SEVERAL VIEWS OF THE DRAWINGS

Referring now to the drawings wherein like elements are numbered alike in the several FIGURES:

FIG. 1 depicts a memory subsystem with multiple stacked memory arrays communicating with a memory controller via a cascade interconnected bus that may be implemented by exemplary embodiments;

FIG. 2 depicts further details of an array controller of a stacked memory array that may be implemented by exemplary embodiments;

FIG. 3 depicts further details of a memory array of a stacked memory array that may be implemented by exemplary embodiments;

FIG. 4 depicts an example of multiple stacked memory arrays on horizontal modules that may be implemented by exemplary embodiments;

FIG. 5 depicts an example of multiple stacked memory arrays on vertical modules that may be implemented by exemplary embodiments;

FIG. 6 depicts a further example of multiple stacked memory arrays on vertical modules that includes ribbon cable connectors and may be implemented by exemplary embodiments;

FIG. 7 depicts an exemplary process for providing a stacked memory array in a cascade interconnected memory system that may be implemented by exemplary embodiments; and

FIG. 8 is a flow diagram of a design process used in semiconductor design, manufacture, and/or test.

### DETAILED DESCRIPTION

The invention as described herein provides a stacked memory array that can be implemented as a single chip including an array controller die coupled to one or more memory array dies in a stacked configuration. In one embodiment, the stacked memory array is separated into an array controller chip coupled to a memory array chip including one or more stacked memory cell array dies. The array controller includes logic to interface to a memory controller via an I/O bus and random access logic for accessing the memory arrays. Stacking memory arrays may result in a reduced footprint when vertical stacking in employed. In an exemplary embodiment, logic in the array controller supports cascade interconnections via the I/O bus. The array controller may be interconnected to the stacked memory array using vertical interconnections, for instance, through-silicon-vias (TSVs). The stacked memory array can be soldered to a board or plugged onto a board as a module. The I/O bus can be implemented as bidirectional or unidirectional links, and can be integrated on a printed circuit board (PCB) and/or wired using flex cables. The boards can be daisy-chained to form a memory system of a computer processing system.

Stacking of memory arrays results in a reduced footprint, and may enable a larger amount of memory density per memory module. Stacking memory arrays can result in a reduction of redundant decoding circuitry that may otherwise be implemented in each memory device with an equivalent amount of memory. For example, a single stacked memory array chip that includes 4 memory cell arrays controlled by a single array controller can result in a reduction of board area and power, as compared to 4 individual DRAM devices with dedicated control logic and arranged in a planar fashion. The array control power and I/O power may be divided by a factor of the number of stacked memory cell arrays. Integrating buffering logic in the array controller with enhanced cascade interconnect bus features enables daisy chaining to further increase total memory capacity. A high-speed bus with features such as error detection, spare bus bit lanes, and variable frame sizes may further enhance reliability, availability, and serviceability of the cascade interconnected stacked memory arrays.

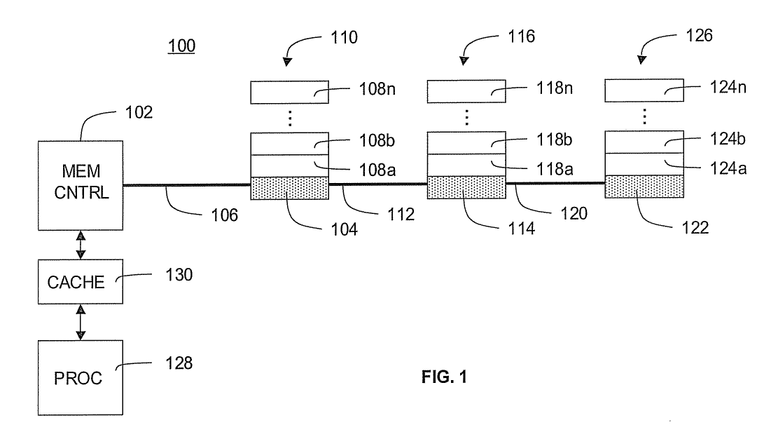

Turning now to FIG. 1, an example of a system 100 that includes a memory controller 102 in communication with an array controller 104 via a bus 106 is depicted. The memory controller 102, array controller 104, and bus 106 may be in a planar configuration. The array controller 104 is interfaced to multiple memory arrays 108a, 108b, up to 108n (where “n” represents an arbitrary number), in a stacked configuration as stacked memory array 110. In an exemplary embodiment, the memory arrays 108a-108n are dies that are coupled using TSVs. The memory controller 102 may transfer data at rates upwards of 6.4 Gigabits per second on the bus 106. The array controller 104 translates memory access commands received on the bus 106 and initiates the requested accesses to the memory arrays 108a-108n. If the array controller 104 determines that memory commands it receives do not target the stacked memory array 110, the array controller 104 forwards the memory commands via bus 112 to array controller 114 of stacked memory array 116. Similarly, if the array controller 114 determines that the memory commands are not targeting memory arrays 118a-118n of the stacked memory array 116, the array controller 114 forwards the memory commands on bus 120 to array controller 122 for memory arrays 124a-124n of stacked memory array 126. The process may continue for additional stacked memory arrays (not depicted).

The busses 106, 112, and 120 may include downstream link segments and upstream link segments as unidirectional links. The term “downstream” indicates that the data is moving away from the memory controller 102. The term “upstream” refers to data moving from the array controllers 104, 114, and/or 122 toward the memory controller 102. The information stream coming from the memory controller 102 can include of a mixture of commands and data to be stored in the stacked memory array 110, 116, and/or 126, as well as redundancy information, which allows for reliable transfers. The information returning to the memory controller 102 can include data retrieved from the stacked memory array 110, 116, and/or 126, as well as redundant information for reliable transfers. Commands and data can be initiated at the memory controller 102 using processing elements known in the art, such as one or more processors 128 and cache memory 130. The memory controller 102, processor 128, and/or cache memory 130 may be combined in a common physical package/chip or distributed between multiple packages/chips.

In an exemplary embodiment, the memory controller 102 has a very wide, high bandwidth connection to one or more processing cores of the processor 128 and cache memory 130. This enables the memory controller 102 to monitor both actual and predicted future data requests. Based on the current and predicted processor 128 and cache memory 130 activities, the memory controller 102 determines a sequence of commands to best utilize the attached memory resources to service the demands of the processor 128 and cache memory 130. This stream of commands is mixed together with data that is written to the stacked memory array 110, 116, and/or 126 in units called “frames”. The array controllers 104, 114, and/or 122 interpret the frames as formatted by the memory controller 102 and translate the contents of the frames into a format compatible with the memory arrays 108a-108n, 118a-118n, and/or 124a-124n.

Although only a single memory channel is depicted in detail in FIG. 1 connecting the memory controller 102 in a daisy chain with the stacked memory array 110, 116, and 126, systems produced with this configuration may include more than one discrete memory channel from the memory controller 102, such as one or more additional daisy chains in parallel with the depicted daisy chain extending between the memory controller 102 and the array controller 122. Moreover, any number of lanes can be included in the busses 106, 112, and 120, where a lane includes link segments that can span multiple cascaded array controllers. For example, downstream link segments of bus 106 can include 13 bit lanes, 2 spare lanes and a clock lane, while the upstream link segments of bus 106 may include 20 bit lanes, 2 spare lanes and a clock lane. To reduce susceptibility to noise and other coupling interference, low-voltage differential-ended signaling may be used for all bit lanes of busses 106, 112, and 120, including one or more differential-ended clocks. The memory controller 102 and the array controllers 104, 114, and 122 may contain numerous features designed to manage the redundant resources, which can be invoked in the event of hardware failures. For example, multiple spare lanes of the bus 106 can be used to replace one or more failed data or clock lane in the upstream and downstream directions.

In one embodiment, one of the spares can be used to replace either a data or clock link, while a second spare is used to repair a data link but not a clock link. This maximizes the ability to survive multiple interconnect hard failures. Additionally, one or more of the spare lanes in the busses 106, 112, and 120 can be used to test for transient failures or establish bit error rates. The spare lanes may be tested and aligned during initialization, and deactivated during normal run-time operation. The frame format, error detection and protocols are the same before and after spare lane invocation.

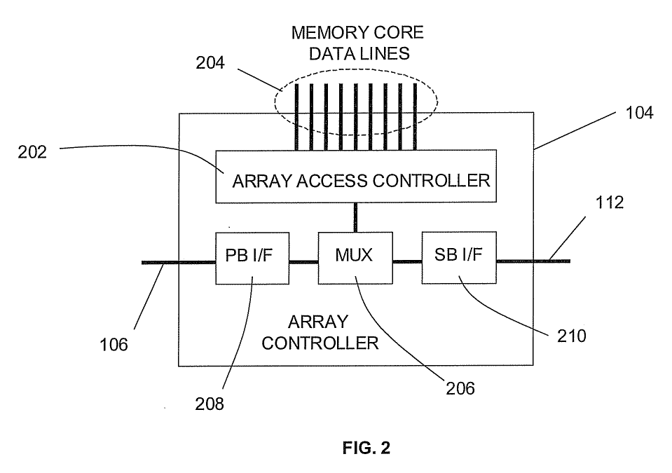

FIG. 2 depicts further details of array controller 104 of stacked memory array 110 of FIG. 1 that may be implemented by exemplary embodiments. Other array controllers, such as array controllers 114 and 122 of FIG. 1, may contain the same or substantially similar elements as depicted in FIG. 2. In an exemplary embodiment, the array controller 104 includes an array access controller 202 that drives memory core data lines 204 that are coupled to the memory arrays 108a-108n of stacked memory array 110. The memory core data lines 204 may be TSVs and include read/write, select, and output enable signal paths. Thus, the array access controller 202 can provide a TSV interface to the memory core data lines 204. The array access controller 202 can include address and decoding logic to determine which of the memory arrays 108a-108n to access in response to memory access commands. The array access controller 202 receives commands and/or data targeted for the memory arrays 108a-108n from multiplexer logic (mux) 206. The mux 206 determines whether frames of commands and/or data received from primary buffer interface 208 are targeting the stacked memory array 110. In response to determining that frames of commands and/or data received via bus 106 at the primary buffer interface 208 target the stacked memory array 110, the mux 206 passes the commands and/or data to the array access controller 202; otherwise, the frames of commands and/or data are passed to secondary buffer interface 210 to be redriven on bus 112.

The mux 206 may simply direct traffic without modifying the contents or formatting of the frames. In an alternate embodiment, the mux 206 converts frames of commands and/or data into a different signal format for the array access controller 202 and reformats data received from the array access controller 202 into a frame format compatible with the primary buffer interface 208 and/or the secondary buffer interface 210. The primary and secondary buffer interfaces 208 and 210 provide buffering in the downstream and upstream directions so that the flow of data and commands can be averaged and optimized to and from the memory controller 102. The format of downstream and upstream frames as well as data rates can vary. For example, downstream frames may include commands and/or data, while upstream frames may include data and/or status information.

Commands and data values communicated on the busses 106, 112, and 120 may be formatted as frames and serialized for transmission at a high data rate, e.g., stepped up in data rate by a factor of 4, 5, 6, 8, etc.; thus, transmission of commands, address and data values is also generically referred to as “data” or “high-speed data”. In contrast, communication on the memory core data lines 204 may be at a lower-speed, since the bus width of the memory core data lines 204 can be wider than the busses 106, 112, and 120. The array access controller 202 or the mux 206 may perform a clock rate conversion to adjust timing between bus formats. In an exemplary embodiment, a configurable PLL is used to switch between clock domains.

The array controller 104 may use a sequence of identifiers to determine the source and destination for frames received at the primary and secondary buffer interfaces 208 and 210. Frames can be sent over multiple transfer cycles. The number of transfers can alternate from frame to frame in order to maintain a desired clock ratio between the bus 106 and the memory core data lines 204. In an exemplary embodiment, downstream data frames are configurable between 8, 12 and 16 transfers per frame, while upstream data frames are 8 transfers per frame, with each transfer including multiple bit lanes. Buffers and delay logic in the primary and secondary buffer interfaces 208 and 210 can be used to prevent collisions between data from the array access controller 202 versus from busses 106 and/or 112.

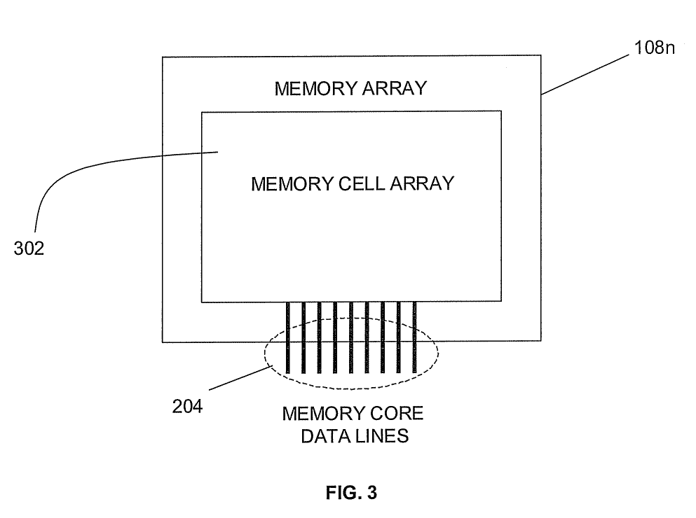

FIG. 3 depicts further details of one of the memory arrays of a stacked memory array that may be implemented by exemplary embodiments. The example of FIG. 3 is memory array 108n of stacked memory array 110 of FIG. 1. Memory array 108n includes a memory cell array 302 coupled to memory core data lines 204. The memory core data lines 204 may be TSVs connected to the array controller 104 of FIGS. 1 and 2. In an exemplary embodiment, the memory cell array 302 includes storage cells, such as dynamic capacitive storage cells. Storage cells can be arranged in an array of rows and columns that is accessed using control and addressing logic of the array access controller 202 of FIG. 2. Additionally, the memory cell array 302 may include local peripheral support circuitry, such as sense amplifiers and logic to refresh the charge in the cells of the memory cell array 302. It will be understood that the structure depicted in FIG. 3 can be implemented in each of the memory arrays 108a-108n, 118a-118n, and/or 124a-124n.

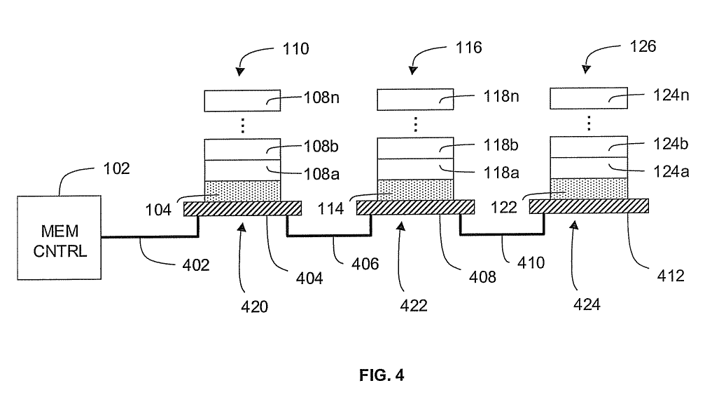

FIG. 4 depicts an example of multiple stacked memory arrays on horizontal modules that may be implemented by exemplary embodiments. In FIG. 4, the stacked memory arrays 110, 116, and 126 of FIG. 1 are isolated on separate boards 404, 408, and 412 respectively to form a series of cascaded horizontally arranged modules 420, 422, and 424. The memory controller 102 passes commands and data via bus 402 to board 404 and array controller 104. Array controller 104 is cascade interconnected from board 404 to array controller 114 on board 408 via bus 406. Similarly, array controller 114 is cascade interconnected from board 408 to array controller 122 on board 412 via bus 410. The busses 402, 406, and/or 410 may include unidirectional connections are described in reference to the busses 106, 112, and 120 of FIG. 1. The horizontally arranged modules 420, 422, and 424 can be mezzanine modules sitting above other circuitry to support a compact design. Additionally, the horizontal configuration depicted in FIG. 4 may support larger or variable stack sizes for each of the stacked memory arrays 110, 116, and 126.

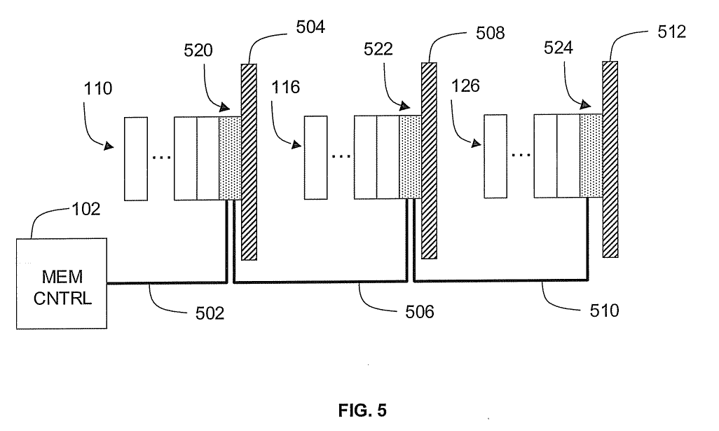

FIG. 5 depicts an example of multiple stacked memory arrays on vertical modules that may be implemented by exemplary embodiments. In FIG. 5, the stacked memory arrays 110, 116, and 126 of FIG. 1 are isolated on separate boards 504, 508, and 512 respectively to form a series of cascaded vertically arranged modules 520, 522, and 524. The memory controller 102 passes commands and data via bus 502 to the stacked memory array 110 on board 504 of module 520. The stacked memory array 110 is cascade interconnected to stacked memory array 116 on board 508 via bus 506. Similarly, the stacked memory array 116 is cascade interconnected to stacked memory array 126 on board 512 via bus 510. The busses 502, 506, and/or 510 may include unidirectional connections are described in reference to the busses 106, 112, and 120 of FIG. 1. The vertically arranged modules 520, 522, and 524 can be edge connected to a motherboard, which may simplify installation and removal of the modules 520, 522, and 524. Additionally, one or both sides of the boards 504, 508, and 512 can be utilized in single-sided or dual sided modules of stacked memory arrays. When both sides of modules 520, 522, and 524 are populated, the stacked memory arrays can be staggered on each module 520, 522, and 524, allowing for overlapping of stacked memory arrays between neighboring modules to further conserve space.

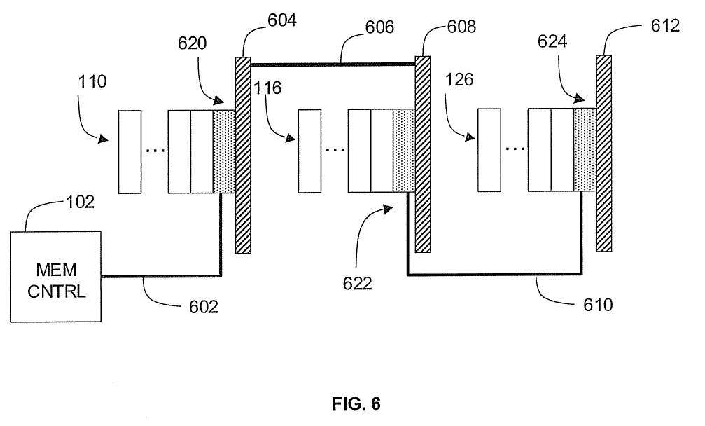

FIG. 6 depicts a further example of multiple stacked memory arrays on vertical modules including ribbon cable connectors that may be implemented by exemplary embodiments. Similar to FIG. 5, In FIG. 5, the stacked memory arrays 110, 116, and 126 of FIG. 1 are isolated on separate boards 604, 608, and 612 respectively to form a series of cascaded vertically arranged modules 620, 622, and 624. The busses 602, 606, and/or 610 may include unidirectional connections are described in reference to the busses 106, 112, and 120 of FIG. 1. Busses 602 and 610 may be routed on a motherboard, while bus 606 is a ribbon cable that provides a communication path between modules 620 and 622. Using a ribbon cable or other flexible link can enable modules 620 and 622 to be physically separated without consuming board space between the modules. Supporting flexible links, such as the bus 606 can also provide an ability to expand the number of modules in a cascade without pre-routing a fixed number of interconnections in the underlying motherboard. It will be understood that horizontal modules may also use flexible links, such as ribbon cables, as well.

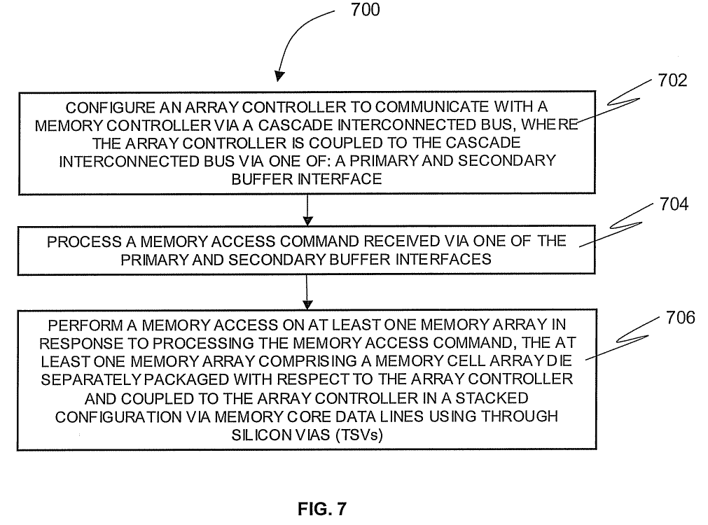

FIG. 7 depicts a process 700 for providing stacked memory arrays that may be implemented as described in reference to FIGS. 1-6, for instance, stacked memory arrays 110, 116, and 126 in the cascade interconnected memory system 100 FIG. 1. The memory system can be configured in variety of architectures, e.g., planar or integrated on horizontal and/or vertical memory modules, with or without flexible links. At block 702, array controller 104 is configured to communicate with memory controller 102 via a cascade interconnected bus on bus 106. The array controller 104 is coupled to the cascade interconnected bus, including segments of busses 106 and 112 via one of: primary and secondary buffer interfaces 208 and 210. The cascade interconnected bus continues as with link segments of busses interconnecting stacked memory arrays 116 and 126 via busses 112 and 120. The busses 106, 112, and/or 120 may include multiple upstream and downstream link segments. In an exemplary embodiment, unidirectional downstream link segments include at least 13 data bit lanes, 2 spare bit lanes and a downstream clock, coupled to the memory controller 102 and operable for transferring data frames configurable between 8, 12 and 16 transfers per frame, with each transfer comprised of multiple bit lanes. The unidirectional upstream link segments may include at least 20 bit lanes, 2 spare bit lanes and an upstream clock, coupled to the memory controller 102 and operable for transferring data frames comprised of 8 transfers per frame, with each transfer comprised of multiple bit lanes.

At block 704, the array controller 104 processes a memory access command received via one of the primary and secondary buffer interfaces 208 and 210. While the array controller 140 typically receives memory access commands via the primary buffer interface 208, the array controller 140 may also support memory access commands received via the secondary buffer interface 210 for additional design flexibility. The mux 206 can direct communications in the array controller 104 between the primary and secondary buffer interfaces 208 and 210 and memory arrays 108a-108n.

At block 706, the array access controller 202 of array controller 104 performs a memory access on at least one memory array 108a-108n in response to processing the memory access command. The memory array 108a-108n include memory cell array dies 302 separately packaged with respect to the array controller 104 and coupled to the array controller 104 in a stacked configuration via memory core data lines 204 using TSVs.

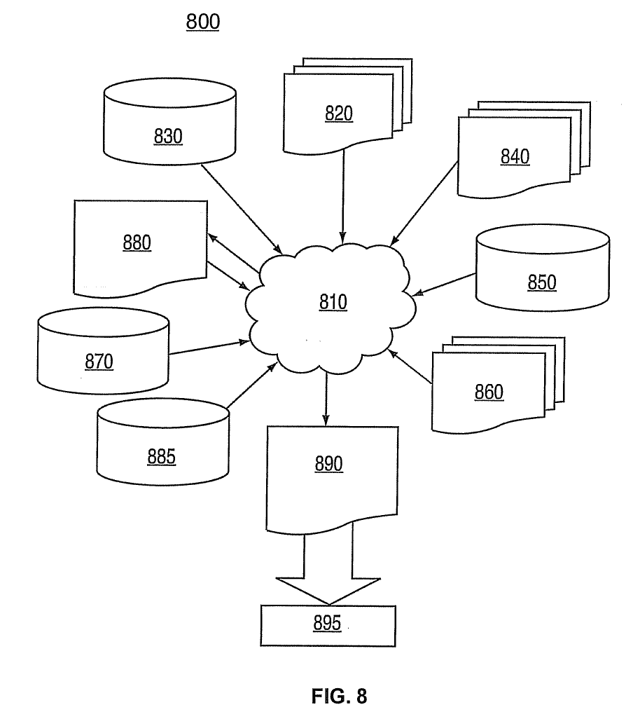

FIG. 8 shows a block diagram of an exemplary design flow 800 used for example, in semiconductor IC logic design, simulation, test, layout, and manufacture. Design flow 800 includes processes and mechanisms for processing design structures or devices to generate logically or otherwise functionally equivalent representations of the design structures and/or devices described above and shown in FIGS. 1-7. The design structures processed and/or generated by design flow 800 may be encoded on machine readable transmission or storage media to include data and/or instructions that when executed or otherwise processed on a data processing system generate a logically, structurally, mechanically, or otherwise functionally equivalent representation of hardware components, circuits, devices, or systems. Design flow 800 may vary depending on the type of representation being designed. For example, a design flow 800 for building an application specific IC (ASIC) may differ from a design flow 800 for designing a standard component or from a design flow 800 for instantiating the design into a programmable array, for example a programmable gate array (PGA) or a field programmable gate array (FPGA) offered by Altera® Inc. or Xilinx® Inc.

FIG. 8 illustrates multiple such design structures including an input design structure 820 that is preferably processed by a design process 810. Design structure 820 may be a logical simulation design structure generated and processed by design process 810 to produce a logically equivalent functional representation of a hardware device. Design structure 820 may also or alternatively comprise data and/or program instructions that when processed by design process 810, generate a functional representation of the physical structure of a hardware device. Whether representing functional and/or structural design features, design structure 820 may be generated using electronic computer-aided design (ECAD) such as implemented by a core developer/designer. When encoded on a machine-readable data transmission, gate array, or storage medium, design structure 820 may be accessed and processed by one or more hardware and/or software modules within design process 810 to simulate or otherwise functionally represent an electronic component, circuit, electronic or logic module, apparatus, device, or system such as those shown in FIGS. 1-7. As such, design structure 820 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 810 preferably employs and incorporates hardware and/or software modules for synthesizing, translating, or otherwise processing a design/simulation functional equivalent of the components, circuits, devices, or logic structures shown in FIGS. 1-7 to generate a netlist 880 which may contain design structures such as design structure 820. Netlist 880 may comprise, for example, compiled or otherwise processed data structures representing a list of wires, discrete components, logic gates, control circuits, I/O devices, models, etc. that describes the connections to other elements and circuits in an integrated circuit design. Netlist 880 may be synthesized using an iterative process in which netlist 880 is resynthesized one or more times depending on design specifications and parameters for the device. As with other design structure types described herein, netlist 880 may be recorded on a machine-readable data storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, buffer space, or electrically or optically conductive devices and materials on which data packets may be transmitted and intermediately stored via the Internet, or other networking suitable means.

Design process 810 may include hardware and software modules for processing a variety of input data structure types including netlist 880. Such data structure types may reside, for example, within library elements 830 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 840, characterization data 850, verification data 860, design rules 870, and test data files 885 which may include input test patterns, output test results, and other testing information. Design process 810 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 810 without deviating from the scope and spirit of the invention. Design process 810 may also include modules for performing standard circuit design processes such as timing analysis, verification, design rule checking, place and route operations, etc.

Design process 810 employs and incorporates logic and physical design tools such as HDL compilers and simulation model build tools to process design structure 820 together with some or all of the depicted supporting data structures along with any additional mechanical design or data (if applicable), to generate a second design structure 890. Design structure 890 resides on a storage medium or programmable gate array in a data format used for the exchange of data of mechanical devices and structures (e.g. information stored in a IGES, DXF, Parasolid XT, JT, DRG, or any other suitable format for storing or rendering such mechanical design structures). Similar to design structure 820, design structure 890 preferably comprises one or more files, data structures, or other computer-encoded data or instructions that reside on transmission or data storage media and that when processed by an ECAD system generate a logically or otherwise functionally equivalent form of one or more of the embodiments of the invention shown in FIGS. 1-7. In one embodiment, design structure 890 may comprise a compiled, executable HDL simulation model that functionally simulates the devices shown in FIGS. 1-7.

Design structure 890 may also employ a data format used for the exchange of layout data of integrated circuits and/or symbolic data format (e.g. information stored in a GDSII (GDS2), GL1, OASIS, map files, or any other suitable format for storing such design data structures). Design structure 890 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown in FIGS. 1-7. Design structure 890 may then proceed to a stage 895 where, for example, design structure 890: proceeds to tape-out, is released to manufacturing, is released to a mask house, is sent to another design house, is sent back to the customer, etc.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Further embodiments include the use of continuity modules, such as those recognized in the art, which, for example, can be placed between the memory controller and a first populated memory module (e.g., a memory module that includes an array controller that is in communication with one or more memory devices), in a cascade interconnect memory system, such that any intermediate module positions between the memory controller and the first populated memory module includes a means by which information passing between the memory controller and the first populated memory module device can be received even if the one or more intermediate module position(s) do not include an array controller. The continuity module(s) may be installed in any module position(s), subject to any bus restrictions, including the first position (closest to the main memory controller, the last position (prior to any included termination) or any intermediate position(s). The use of continuity modules may be especially beneficial in a multi-module cascade interconnect bus structure, where an intermediate array controller on a memory module is removed and replaced by a continuity module, such that the system continues to operate after the removal of the intermediate array controller/module. In more common embodiments, the continuity module(s) would include either interconnect wires to transfer all required signals from the input(s) to the corresponding output(s), or be re-driven through a repeater device. The continuity module(s) might further include a non-volatile storage device (such as an EEPROM), but would not include conventional main memory storage devices such as one or more volatile memory device(s). In other exemplary embodiments, the continuity or re-drive function may be comprised as an array controller that is not placed on a memory module (e.g. the one or more array controller(s) may be attached directly to the system board or attached to another carrier), and may or may not include other devices connected to it to enable functionality.

Although generally not shown in the Figures, the memory modules or array controllers may also include one or more separate bus(es), such as a “presence detect” (e.g. a module serial presence detect bus), an I2C bus, a JTAG bus, an SMBus or other bus(es) which are primarily used for one or more purposes such as the determination of the array controller and/or memory module attributes (generally after power-up), the configuration of the array controller(s) and/or memory subsystem(s) after power-up or during normal operation, bring-up and/or training of the high speed interfaces (e.g. bus(es)), the reporting of fault or status information to the system and/or testing/monitoring circuitry, the determination of specific failing element(s) and/or implementation of bus repair actions such as bitlane and/or segment sparing, the determination of one or more failing devices (e.g. memory and/or support device(s)) possibly with the invoking of device replacement (e.g. device “sparing”), parallel monitoring of subsystem operation or other purposes, etc. The one or more described buses would generally not be intended for primary use as high speed memory communication bus(es). Depending on the bus characteristics, the one or more bus(es) might, in addition to previously described functions, also provide a means by which the valid completion of operations and/or failure identification could be reported by the array controllers and/or memory module(s) to the memory controller(s), the processor, a service processor, a test device and/or other functional element permanently or temporarily in communication with the memory subsystem and/or array controller.

Optical bus solutions may permit significantly increased frequency and bandwidth vs. the previously-described bus structures, using point-to-point or multi-drop or related structures, but may incur cost and/or space impacts when using contemporary technologies.

Also as used herein, the term “bus” refers to one of the sets of conductors (e.g., wires, printed circuit board traces or other connection means) between devices, cards, modules and/or other functional units. The data bus, address bus and control signals, despite their names, generally constitute a single bus since each are often useless without the others. A bus may include a plurality of signal lines, each signal line having two or more connection points that form a transmission path that enables communication between two or more transceivers, transmitters and/or receivers. The term “channel”, as used herein, refers to the one or more busses containing information such as data, address(es), command(s) and control(s) to be sent to and received from a system or subsystem, such as a memory, processor or I/O system. Note that this term is often used in conjunction with I/O or other peripheral equipment; however the term channel has also been utilized to describe the interface between a processor or memory controller and one of one or more memory subsystem(s).

Further, as used herein, the term “daisy chain” refers to a bus wiring structure in which, for example, device A is wired to device B, device B is wired to device C, etc. . . . The last device is typically wired to a resistor or terminator. All devices may receive identical signals or, in contrast to a simple bus, each device may modify, re-drive or otherwise act upon one or more signals before passing them on. A “cascade” or cascade interconnect’ as used herein refers to a succession of stages or units or a collection of interconnected networking devices in which the array controllers operate as a logical repeater, further permitting merging data to be concentrated into the existing data stream. The terms daisy chain and cascade connect may be used interchangeably when a daisy chain structure includes some form of re-drive and/or “repeater” function. Also as used herein, the term “point-to-point” bus and/or link refers to one or a plurality of signal lines that may each include one or more terminators. In a point-to-point bus and/or link, each signal line has two transceiver connection points, with each transceiver connection point coupled to transmitter circuitry, receiver circuitry or transceiver circuitry. A signal line refers to one or more electrical conductors, optical carriers and/or other information transfer method, generally configured as a single carrier or as two or more carriers, in a twisted, parallel, or concentric arrangement, used to transport at least one logical signal.

Storage cells of the memory cell arrays may store information in the form of electrical, optical, magnetic, biological or other means. The stacked memory arrays may be utilized in the form of chips (die) and/or single or multi-chip packages of various types and configurations. In multi-chip packages, the stacked memory arrays may be packaged with other device types such as other memory devices, logic chips, analog devices and programmable devices, and may also include passive devices such as resistors, capacitors and inductors. These packages may include an integrated heat sink or other cooling enhancements, which may be further attached to the immediate carrier or another nearby carrier or heat removal system.

Module support devices (such as buffers, logic chips, registers, PLL's, DLL's, non-volatile memory, etc) may be comprised of multiple separate chips and/or components, may be combined as multiple separate chips onto one or more substrates, may be combined onto a single package and/or or integrated onto a single device—based on technology, power, space, cost and other tradeoffs. In addition, one or more of the various passive devices such as resistors, capacitors may be integrated into the support chip packages and/or into the substrate, board or raw card itself, based on technology, power, space, cost and other tradeoffs. These packages may also include one or more heat sinks or other cooling enhancements, which may be further attached to the immediate carrier or be part of an integrated heat removal structure that contacts more than one support and/or stacked memory arrays.

Stacked memory arrays, buffers, registers, clock devices, passives and other memory support devices and/or components may be attached to the memory subsystem via various methods including solder interconnects, conductive adhesives, socket assemblies, pressure contacts and other methods which enable communication between the two or more devices and/or carriers via electrical, optical or alternate communication means.

The one or more memory modules, memory cards and/or alternate memory subsystem assemblies and/or array controllers may be electrically connected to the memory system, processor complex, computer system or other system environment via one or more methods such as soldered interconnects, connectors, pressure contacts, conductive adhesives, optical interconnects and other communication and power delivery methods. Inter-connection systems may include mating connectors (e.g. male/female connectors), conductive contacts and/or pins on one carrier mating with a compatible male or female connection means, optical connections, pressure contacts (often in conjunction with a retaining mechanism) and/or one or more of various other communication and power delivery methods. The interconnection(s) may be disposed along one or more edges of the memory assembly, may include one or more rows of interconnections and/or be located a distance from an edge of the memory subsystem depending on such application requirements as the connection structure, the number of interconnections required, performance requirements, ease of insertion/removal, reliability, available space/volume, heat transfer/cooling, component size and shape and other related physical, electrical, optical, visual/physical access, etc. Electrical interconnections on contemporary memory modules are often referred to as contacts, pins, tabs, etc. Electrical interconnections on a contemporary electrical connector are often referred to as contacts, pads, pins, pads, etc.

As used herein, the term memory subsystem refers to, but is not limited to one or more stacked memory arrays and associated interface and/or timing/control circuitry and/or one or more stacked memory arrays in conjunction with a buffer, array controller, and/or switch, identification devices, etc.; generally assembled onto one or more substrate(s), card(s), module(s) or other carrier type(s), which may further include additional means for attaching other devices. The memory modules described herein may also be referred to as memory subsystems because they include one or more memory array and other supporting device(s).

Additional functions that may reside local to the memory subsystem and/or array controller include write and/or read buffers, one or more levels of local memory cache, local pre-fetch logic (allowing for self-initiated pre-fetching of data), data encryption/decryption, compression/de-compression, address and/or command protocol translation, command prioritization logic, voltage and/or level translation, error detection and/or correction circuitry on one or more busses, data scrubbing, local power management circuitry (which may further include status reporting), operational and/or status registers, initialization circuitry, self-test circuitry (testing logic and/or memory in the subsystem), performance monitoring and/or control, one or more co-processors, search engine(s) and other functions that may have previously resided in the processor, memory controller or elsewhere in the memory system. Memory controller functions may also be included in the memory subsystem such that one or more of non-technology-specific commands/command sequences, controls, address information and/or timing relationships can be passed to and from the memory subsystem, with the subsystem completing the conversion, re-ordering, re-timing between the non-memory technology-specific information and the memory technology-specific communication means as necessary. By placing more technology-specific functionality local to the memory subsystem, such benefits as improved performance, increased design flexibility/extendibility, etc., may be obtained, often while making use of unused circuits within the subsystem.

Memory subsystem support device(s) may be directly attached to the same substrate or assembly onto which the stacked memory array(s) are attached, or may be mounted to a separate interposer, substrate, card or other carrier produced using one or more of various plastic, silicon, ceramic or other materials which include electrical, optical or other communication paths to functionally interconnect the support device(s) to the stacked memory array(s) and/or to other elements of the memory subsystem or memory system.

Information transfers (e.g. packets) along a bus, channel, link or other interconnection means may be completed using one or more of many signaling options. These signaling options may include one or more of such means as single-ended, differential, optical or other communication methods, with electrical signaling further including such methods as voltage and/or current signaling using either single or multi-level approaches. Signals may also be modulated using such methods as time or frequency, non-return to zero, phase shift keying, amplitude modulation and others. Signal voltage levels are expected to continue to decrease, with 1.5V, 1.2V, 1V and lower signal voltages expected, as a means of reducing power, accommodating reduced technology breakdown voltages, etc.—in conjunction with or separate from the power supply voltages. One or more power supply voltages may drop at a slower rate than the I/O voltage(s) due in part to the technological challenges of storing information in dynamic memory cells.

One or more clocking methods may be utilized within the memory subsystem and the memory system itself, including global clocking, source-synchronous clocking, encoded clocking or combinations of these and other methods. The clock signaling may be identical to that of the signal (often referred to as the bus “data”) lines themselves, or may utilize one of the listed or alternate methods that is more conducive to the planned clock frequency(ies), and the number of clocks required for various operations within the memory system/subsystem(s). A single clock may be associated with all communication to and from the stacked memory arrays, as well as all clocked functions within the memory subsystem, or multiple clocks may be sourced using one or more methods such as those described earlier. When multiple clocks are used, the functions within the memory subsystem may be associated with a clock that is uniquely sourced to the memory subsystem and/or may be based on a clock that is derived from the clock included as part of the information being transferred to and from the memory subsystem (such as that associated with an encoded clock). Alternately, a unique clock may be used for the information transferred to the memory subsystem, and a separate clock for information sourced from one (or more) of the memory subsystems. The clocks themselves may operate at the same or frequency multiple of the communication or functional frequency, and may be edge-aligned, center-aligned or placed in an alternate timing position relative to the data, command or address information.

Information passing to the memory subsystem(s) will generally be composed of address, command and data, as well as other signals generally associated with requesting or reporting status or error conditions, resetting the memory, completing memory or logic initialization and/or other functional, configuration or related operations. Information passing from the memory subsystem(s) may include any or all of the information passing to the memory subsystem(s), however generally will not include address and command information. The information passing to or from the memory subsystem(s) may be delivered in a manner that is consistent with normal memory device interface specifications (generally parallel in nature); however, all or a portion of the information may be encoded into a ‘packet’ structure, which may further be consistent with future memory interfaces or delivered using an alternate method to achieve such goals as an increase communication bandwidth, an increase in memory subsystem reliability, a reduction in power and/or to enable the memory subsystem to operate independently of the memory technology. In the latter case, the memory subsystem (e.g., the array controller) would convert and/or schedule, time, etc. the received information into the format required by the receiving device(s).

Initialization of the memory subsystem may be completed via one or more methods, based on the available interface busses, the desired initialization speed, available space, cost/complexity, the subsystem interconnect structures involved, the use of alternate processors (such as a service processor) which may be used for this and other purposes, etc. In one embodiment, the high speed bus may be used to complete the initialization of the memory subsystem(s), generally by first completing a step-by-step training process to establish reliable communication to one, more or all of the memory subsystems, then by interrogation of the attribute or ‘presence detect’ data associated the one or more various memory assemblies and/or characteristics associated with any given subsystem, and ultimately by programming any/all of the programmable devices within the one or more memory subsystems with operational information establishing the intended operational characteristics for each subsystem within that system. In a cascaded system, communication with the memory subsystem closest to the memory controller would generally be established first, followed by the establishment of reliable communication with subsequent (downstream) subsystems in a sequence consistent with their relative position along the cascade interconnect bus.

A second initialization method would include one in which the high-speed bus is operated at one frequency during the initialization process, then at a second (and generally higher) frequency during the normal operation. In this embodiment, it may be possible to initiate communication with any or all of the memory subsystems on the cascade interconnect bus prior to completing the interrogation and/or programming of each subsystem, due to the increased timing margins associated with the lower frequency operation.

A third initialization method may include operation of the cascade interconnect bus at the normal operational frequency(ies), while increasing the number of cycles associated with each address, command and/or data transfer. In one embodiment, a packet containing all or a portion of the address, command and/or data information might be transferred in one clock cycle during normal operation, but the same amount and/or type of information may be transferred over two, three or more cycles during initialization. This initialization process would therefore be using a form of ‘slow’ commands, rather than ‘normal’ commands, and this mode might be automatically entered at some point after power-up and/or re-start by each of the subsystems and the memory controller by way of POR (power-on-reset) logic and/or other methods such as a power-on-rest detection via detection of a slow command identifying that function.

A fourth initialization method may utilize a distinct bus, such as a presence detect bus, an I2C bus, and/or the SMBUS, which has been widely utilized and documented in computer systems using such memory modules. This bus may be connected to one or more modules within a memory system in a daisy chain/cascade interconnect, multi-drop or alternate structure, providing an independent means of interrogating memory subsystems, programming each of the one or more memory subsystems to operate within the overall system environment, and adjusting the operational characteristics at other times during the normal system operation based on performance, thermal, configuration or other changes desired or detected in the system environment.

Other methods for initialization can also be used, in conjunction with or independent of those listed. The use of a separate bus, such as described in the fourth embodiment above, also provides an independent means for both initialization and uses other than initialization including changes to the subsystem operational characteristics on-the-fly and for the reporting of and response to operational subsystem information such as utilization, temperature data, failure information or other purposes.

With improvements in lithography, better process controls, the use of materials with lower resistance, increased field sizes and other semiconductor processing improvements, increased device circuit density (often in conjunction with increased die sizes) may facilitate increased function on integrated devices as well as the integration of functions previously implemented on separate devices. This integration can serve to improve overall performance of the memory system and/or subsystem(s), as well as provide such system benefits as increased storage density, reduced power, reduced space requirements, lower cost, higher performance and other manufacturer and/or customer benefits. This integration is a natural evolutionary process, and may result in the need for structural changes to the fundamental building blocks associated with systems.

The integrity of the communication path, the data storage contents and all functional operations associated with each element of a memory system or subsystem can be assured, to a high degree, with the use of one or more fault detection and/or correction methods. Any or all of the various elements may include error detection and/or correction methods such as CRC (Cyclic Redundancy Code), EDC (Error Detection and Correction), parity or other encoding/decoding methods suited for this purpose. Further reliability enhancements may include operation re-try (to overcome intermittent faults such as those associated with the transfer of information), the use of one or more alternate or replacement communication paths and/or portions of such paths (e.g. “segments” of end-to-end “bitlanes”) between a given memory subsystem and the memory controller to replace failing paths and/or portions of paths, complement-re-complement techniques and/or alternate reliability enhancement methods as used in computer, communication and related systems.

The use of bus termination, on busses ranging from point-to-point links to complex multi-drop structures, is becoming more common consistent with increased performance demands. A wide variety of termination methods can be identified and/or considered, and include the use of such devices as resistors, capacitors, inductors or any combination thereof, with these devices connected between the signal line and a power supply voltage or ground, a termination voltage (such voltage directly sourced to the device(s) or indirectly sourced to the device(s) from a voltage divider, regulator or other means), or another signal. The termination device(s) may be part of a passive or active termination structure, and may reside in one or more positions along one or more of the signal lines, and/or as part of the transmitter and/or receiving device(s). The terminator may be selected to match the impedance of the transmission line, be selected as an alternate impedance to maximize the usable frequency, signal swings, data widths, reduce reflections and/or otherwise improve operating margins within the desired cost, space, power and other system/subsystem limits.

Technical effects include stacking memory arrays to increase memory density for a given footprint. Separating memory access control logic from the memory array may reduce redundant logic blocks that would otherwise be repeated in each discrete memory device. Incorporating a cascade interconnected bus structure in the array controller may further reduce the need for separate hub devices and multiple memory devices per module. Arranging the stacked memory arrays on horizontal and/or vertical modules provides placement options in the layout of a larger system. TSVs may further reduce package size requirements, as the number of external pins and external interconnections is reduced. The compact design may also lower weight and power consumption for a given amount of memory as compared to the use of discrete memory devices, such as commodity DRAM chips.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Moreover, the use of the terms first, second, etc. do not denote any order or importance, but rather the terms first, second, etc. are used to distinguish one element from another.

What is claimed is:

1. A memory subsystem comprising:
an array controller comprising:
a primary and secondary buffer interface to communicate with a memory controller via a cascade interconnected bus; and
an array access controller to process memory access commands received via one of the primary and secondary buffer interfaces; and
at least one memory array comprising a memory cell array die separately packaged with respect to the array controller and coupled to the array controller in a stacked configuration via memory core data lines using through silicon vias (TSVs).

2. The memory subsystem of claim 1 further comprising a multiplexer to direct communications between the array access controller, the primary buffer interface, and the secondary buffer interface.

3. The memory subsystem of claim 1 wherein multiple memory arrays comprised of memory cell arrays are coupled to the memory core data lines using the TSVs in a stacked configuration.

4. The memory subsystem of claim 1 wherein the array controller and the at least one memory array are mounted on a board to form a module.

5. The memory subsystem of claim 4 wherein the module is mounted horizontally.

6. The memory subsystem of claim 4 wherein the module is mounted vertically.

7. The memory subsystem of claim 4 wherein the module includes a connection for a flexible cable to cascade interconnect the module to a second module.

8. The memory subsystem of claim 1 wherein the cascade interconnected bus is comprised of:
unidirectional downstream link segments including at least 13 data bit lanes, 2 spare bit lanes and a downstream clock, coupled to the memory controller and operable for transferring data frames configurable between 8, 12 and 16 transfers per frame, with each transfer comprised of multiple bit lanes; and
unidirectional upstream link segments including at least 20 bit lanes, 2 spare bit lanes and an upstream clock, coupled to the memory controller and operable for transferring data frames comprised of 8 transfers per frame, with each transfer comprised of multiple bit lanes.

9. An array controller comprising:
a primary and secondary buffer interface to communicate with a memory controller via a cascade interconnected bus;
an array access controller to process memory access commands received via one of the primary and secondary buffer interfaces; and
a through silicon via (TSV) interface to communicate via memory core data lines with at least one memory array comprising a memory cell array die separately packaged with respect to the array controller in a stacked configuration.

10. The array controller of claim 9 further comprising a multiplexer to direct communications between the array access controller, the primary buffer interface, and the secondary buffer interface.

11. The array controller of claim 9 wherein the cascade interconnected bus is comprised of:
unidirectional downstream link segments including at least 13 data bit lanes, 2 spare bit lanes and a downstream clock, coupled to the memory controller and operable for transferring data frames configurable between 8, 12 and 16 transfers per frame, with each transfer comprised of multiple bit lanes; and
unidirectional upstream link segments including at least 20 bit lanes, 2 spare bit lanes and an upstream clock, coupled to the memory controller and operable for transferring data frames comprised of 8 transfers per frame, with each transfer comprised of multiple bit lanes.

12. A method comprising:
configuring an array controller to communicate with a memory controller via a cascade interconnected bus, wherein the array controller is coupled to the cascade interconnected bus via one of: a primary and secondary buffer interface;
processing a memory access command received via one of the primary and secondary buffer interfaces; and
performing a memory access on at least one memory array in response to processing the memory access command, the at least one memory array comprising a memory cell array die separately packaged with respect to the array controller and coupled to the array controller in a stacked configuration via memory core data lines using through silicon vias (TSVs).

13. The method of claim 12 further comprising directing communications in the array controller between the primary and secondary buffer interface and the at least one memory array.

14. The method of claim 12 wherein the array controller and the at least one memory array are mounted on a board to form a module.

15. The method of claim 14 wherein the module is mounted one of horizontally and vertically.

16. The method of claim 12 wherein the cascade interconnected bus is comprised of:
unidirectional downstream link segments including at least 13 data bit lanes, 2 spare bit lanes and a downstream clock, coupled to the memory controller and operable for transferring data frames configurable between 8, 12 and 16 transfers per frame, with each transfer comprised of multiple bit lanes; and
unidirectional upstream link segments including at least 20 bit lanes, 2 spare bit lanes and an upstream clock, coupled to the memory controller and operable for transferring data frames comprised of 8 transfers per frame, with each transfer comprised of multiple bit lanes.

17. A design structure tangibly embodied in a machine-readable medium for designing, manufacturing, or testing an integrated circuit, the design structure comprising:
a primary and secondary buffer interface to communicate with a memory controller via a cascade interconnected bus;
an array access controller to process memory access commands received via one of the primary and secondary buffer interfaces; and
a through silicon via (TSV) interface to communicate via memory core data lines with at least one memory array comprising a memory cell array die separately packaged with respect to the array controller in a stacked configuration.

18. The design structure of claim 17, wherein the design structure comprises a netlist.

19. The design structure of claim 17, wherein the design structure resides on storage medium as a data format used for the exchange of layout data of integrated circuits.

20. The design structure of claim 17, wherein the design structure resides in a programmable gate array.
